(19) United States
(12) Patent Application Publication
(10) Pub. No.: US 2007/0033097 A1
(43) Pub. Date: Feb. 8, 2007

(54) Method of providing incentives to customers

(76) Inventor: Scott Woolford, West Pennant Hills (AU)

Correspondence Address: STEPTO & JOHNSON LLP, 1330 CONNECTICUT AVENUE, NW, WASHINGTON, DC, 20009, US

(21) Appl. No.: 10/539,462

(22) PCT Filed: Dec. 18, 2003
(86) PCT No.: PCT/AU03/01686

§ 371 Date: Oct. 3, 2006

(30) Foreign Application Priority Data
Dec. 18, 2002 (AU) 2002953424

(51) Int. Cl. G06Q 30/00

(52) U.S. Cl. 705/14

(57) ABSTRACT

A method of providing incentives for customers to purchase goods or services from amongst a network of vendors including the step of providing a customer with a reward whenever the customer meets a reward criteria of a rewarding vendor, wherein the said reward is redeemable by a redeeming vendor in the network when the customer meets a redemption criteria of the said redeeming vendor, whereby, the redemption of the reward results in the redeeming vendor providing the customer with a further reward.

### TECHNICAL FIELD

The present invention relates to a method of providing incentives to customers. In particular, the present invention relates to a method of providing incentives to customers to purchase goods or services from amongst an exclusive network of vendors.

### BACKGROUND OF THE INVENTION

Various incentive schemes have been used to generate customer traffic amongst certain vendor stores. For instance discount coupons or the like may be distributed freely to prospective customers which are redeemable for a discount on the price of goods or services offered by a specified vendor. However, such schemes are deficient in that they only tend to encourage customers to shop at a single vendor store or chain of stores. Moreover, once the benefit of the discount coupon has been redeemed, there is little motivation for the customer to continue shopping with that same vendor or chain of vendors on an on-going basis.

### SUMMARY OF THE INVENTION

The present invention seeks to provide a method of providing incentives for a customer to purchase goods or services from amongst an exclusive network of vendors.

In a first broad form, the present invention provides a method of providing incentives for customers to purchase goods or services from amongst a network of vendors including the step of providing a customer with a reward whenever the customer meets a reward criteria of a rewarding vendor, wherein the said reward is redeemable by a redeeming vendor in the network when the customer meets a redemption criteria of the said redeeming vendor, whereby, the redemption of the reward results in the redeeming vendor providing the customer with a further reward.

Preferably, the reward criteria includes the customer having to purchase goods or services from the rewarding vendor in the network. Also preferably, the reward criteria includes the customer having to present a membership card to the rewarding vendor in the network. According to one aspect of the present invention, customers pay a membership fee in order to receive a membership card. According to a further aspect of the present invention, customers are provided with an initial offer of a discount on goods or services from at least one vendor in the network in exchange for the purchase of a membership card. This is particularly advantageous in encouraging customers to make an initial purchase from a vendor in the network after which, the customer will be rewarded with incentives to continue shopping at other vendors in the network on an on-going basis. Typically, the offer is provided in the form of a coupon which may be either in the form of a written ticket, or, in an electronic format such as an e-mail accessible via the Internet.

Preferably the reward includes a redeemable credit, said credit being redeemable for a discount on the cost of goods or services provided by a redeeming vendor in the network. According to one aspect of the present invention, the redeemable credit is recorded by the vendor issuing the reward at the point of sale. Alternatively, it would be understood by a person skilled in the art that in other embodiments of the present invention, a third party may be responsible for administering the issuing of a reward to a customer who has met with the reward criteria of a vendor in the network.

According to an aspect of the present invention, the credit may be provided such that it is only redeemable at a limited number of specified vendors in the network. This is advantageous in situations where it is desirable to steer customer traffic towards a specific vendor or vendors in the network.

According to an aspect of the present invention, credit is redeemable within a specified time period. This provides an added incentive for customers to redeem credit in a timely manner. More preferably, the specified time period allocated to any given lot of issued credit is dependant upon the value of a purchase paid by a customer in order to obtain the credit in question. This encourages customers to spend a larger amount of money for a vendor's goods or services in order to receive credit with a longer life span.

According to an aspect of the present invention, smart cards are used as the membership cards. According to a further aspect of the present invention, information may be recorded on the smart card including, amongst other things, the identity of the customer in possession of the membership card and the amount of redeemable credit available to the customer at any given time. Preferably, the information on the smart card is updated whenever the customer makes a purchase or redeems credit.

According to an aspect of the present invention, the redemption criteria includes the customer having to redeem credit at a redeeming vendor. According to a further aspect of the present invention, the redemption criteria also includes the customer having to purchase goods or services from the redeeming vendor in order to redeem any credit for a discount on goods and or services from the vendor, and, if the purchase meets the reward criteria of the redeeming vendor, a further reward may be issued to the customer. Thus, it would be evident to a person skilled in the art that this system advantageously seeks to provide a cycle of incentives whereby the customer may be rewarded on an on-going basis for shopping at vendors within the network.

According to yet another aspect of the present invention, an information directory is provided wherein the information directory may include, amongst other things, details of the reward criteria, redemption criteria and the nature and availability of goods or services provided by each vendor in the network at any given time. Typically, the information directory is presented as a publication in World Wide Web page format accessible via the Internet. The information directory provides an added incentive for customers to shop at vendor stores within the network rather than shop with a vendor outside of the network, as it provides convenient and streamlined access to information regarding goods or services that can be obtained by redeeming any credit a customer may have acquired. In accordance with yet another aspect of the present invention, each vendor in the network will have access to the information directory and is able to update it whenever a customer receives or redeems credit with the said vendor.

In another aspect of the present invention, the vendors in the network mutually agree as to the value of any rewards offered to, and/or reward criteria that must be met by customers.

In accordance with yet another aspect of the present invention, each vendor in the network may be both a redeeming vendor and a rewarding vendor. Thus, a customer may obtain a credit from any given vendor in the network, and then redeem the credit at that same vendor for a discount on the cost of goods or services provided by that vendor if so desired.

In accordance with another aspect of the present invention, the network of vendors is established by selecting prospective vendors which meet a selection criteria. The selection criteria may include, amongst other things, a consideration as to the location of the prospective vendor and/or the nature of goods or services sold by the prospective vendor. This selection process helps to control the overall make-up of the network. This is advantageous for instance in order to place a limit upon the numbers of similar vendors within the network such that vendors within the network will not be faced with excessive competition by other vendors within the network.

In accordance with a further aspect of the present invention, all vendors in the network are issued with a vendor membership card.

### BRIEF DESCRIPTION OF DRAWINGS

The present invention will become more fully understood from the following detailed description of a preferred but non-limiting embodiment thereof, described in connection with the accompanying drawings, wherein:

FIG. 1 shows a topological view of a vendor network used in a first embodiment of the present invention.

FIG. 2 shows a first embodiment of a coupon which provides an incentive for customers to become members of the network.

FIG. 3 shows a first embodiment of a vendor membership card.

FIG. 4 shows a first embodiment of customer membership card.

FIG. 5 shows a flow diagram indicating the steps taken in a first aspect of the first embodiment of the present invention.

FIG. 6 shows a flow diagram indicating the steps taken in a second aspect of the first embodiment of the present invention.

### MODES FOR CARRYING OUT THE INVENTION

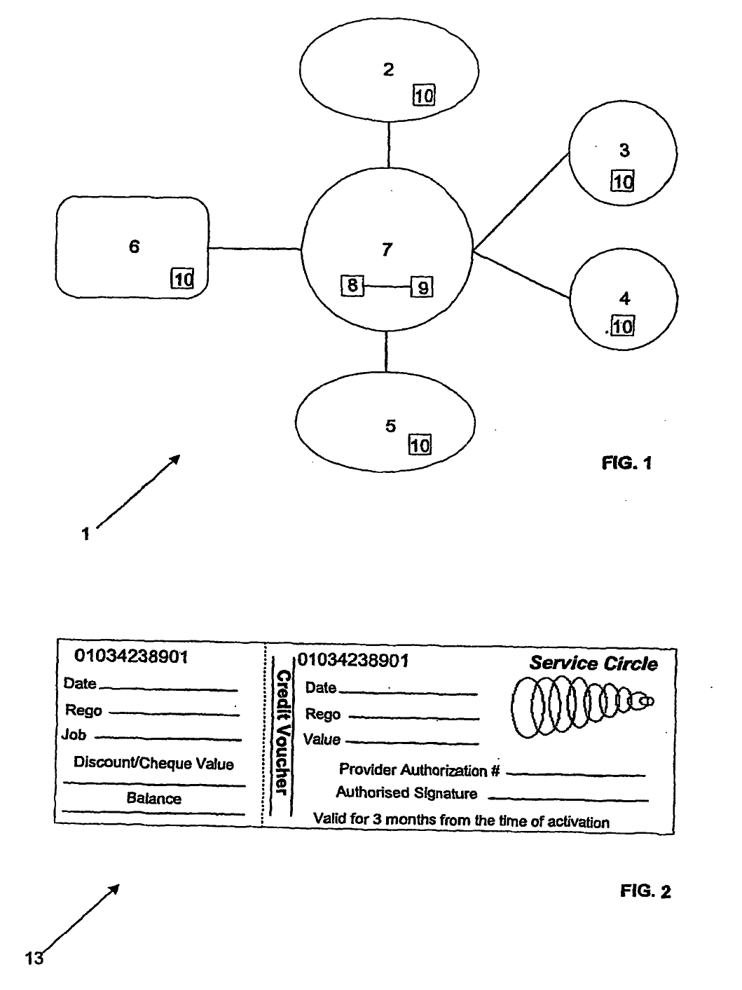

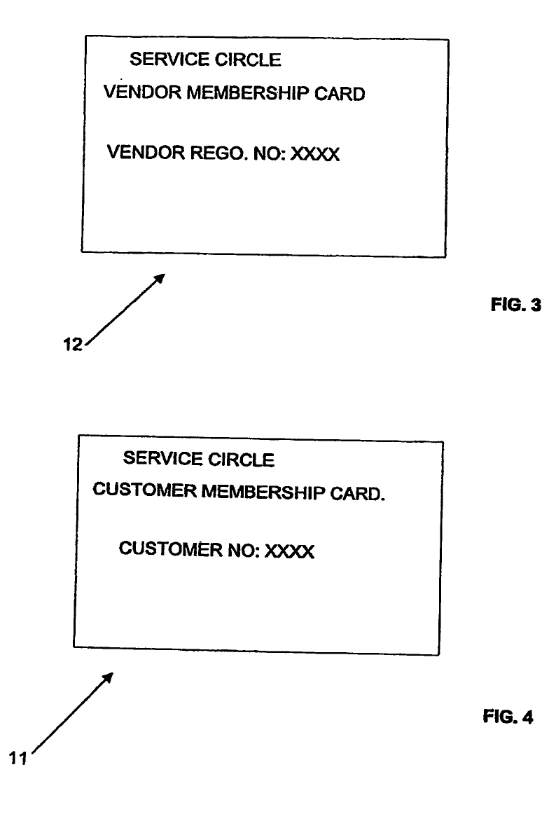

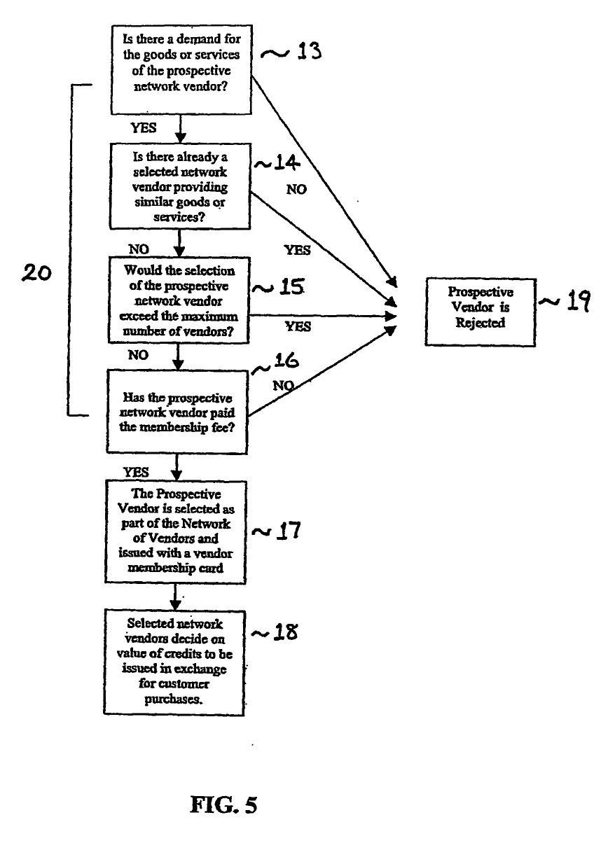

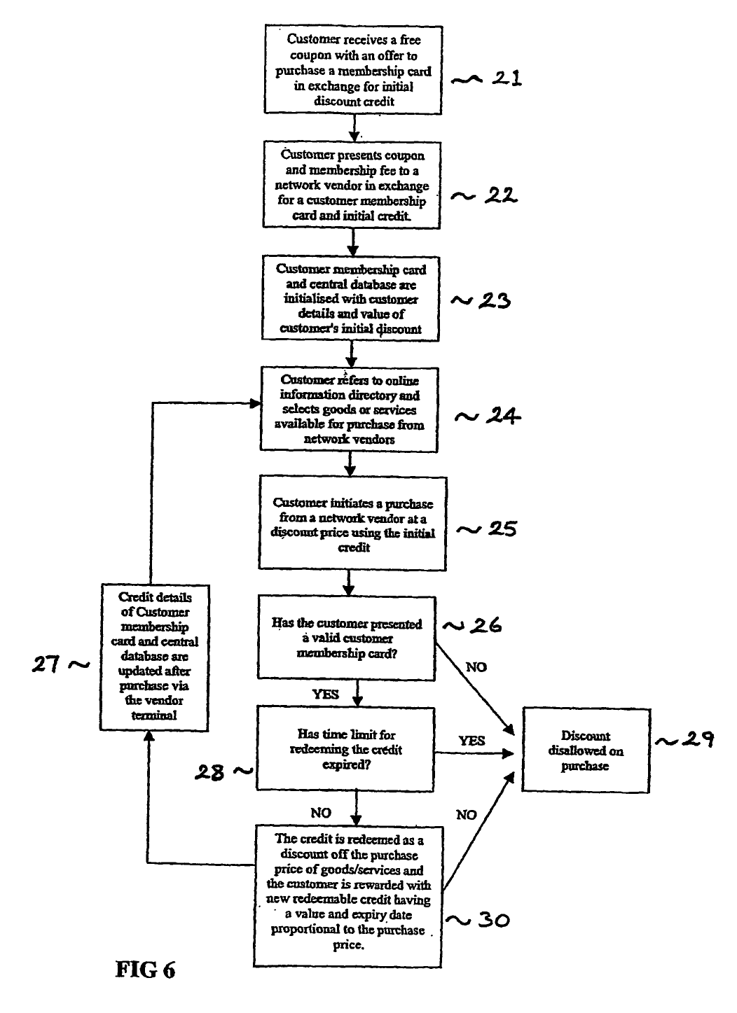

FIGS. 1 to 4 broadly depict the architecture underlying a first embodiment of the present invention, and FIGS. 5 and 6 indicate steps involved in aspects of the first embodiment in the form of flow diagrams. In this embodiment, a network (1) of vendor stores is formed by firstly implementing a selection criteria (20) to select vendors as part of the network (1).

FIG. 5 indicates the steps that are taken in implementing the selection criteria (20) in the first embodiment. The selection criteria (20) includes, amongst other things, a consideration of the demand (13) for the goods and services of a prospective network vendor. By way of example, the selected network vendors includes a service station (2), a dentist (3), a butcher (4), a florist (5), a plumber (6) and an Internet service provider (7) all of which have been selected on the basis that there will be an on-going demand for the particular goods or services of each of these member vendors.

The selection criteria (20) also includes a consideration as to whether the prospective network vendor provides similar goods or services to those provided by an already selected network vendor as shown at (14) in FIG. 5. If this is the case, then over-competition within the network may result. Thus, in the first embodiment, only one vendor is selected at any one time which provides a specific category of goods or services.

A further step in the implementation of the selection criteria (20) includes a consideration as to whether the selection of the prospective network vendor would exceed a maximum limit on the number of network vendors allowed. This step is indicated at (15) of FIG. 5. By way of example only, a maximum of four vendors are permitted as members of the network (1) at any given time. It would be appreciated by a person skilled in the art that the maximum number of vendors within the network (1) may be greater or fewer than four depending upon the individual circumstances or needs of the vendors in the network (1).

In the present embodiment, vendors which have been invited to join the network (1) are required to perform the further step of paying an annual membership fee of $297.00 which is collected by a designated vendor agreed upon by the consensus of the member vendors. This step is indicated at (16) in FIG. 5. In this embodiment, the Internet service provider (7) is designated as the collecting vendor. Membership fees are used to cover the costs of advertising and promoting the network (1) as well as the costs involved in maintaining the information directory. Member vendors are provided with a vendor membership card (12) upon payment of the membership fee whereby the membership card provides proof that the vendor is a valid member of the network (1). The step of providing the vendor membership card (12) to a valid member vendor is indicated at (17) of FIG. 5.

If a prospective vendor fails to meet the selection criteria (20), then it is rejected from joining the network (1). This is indicated at (19) of FIG. 5.

The vendors selected to be part of the network (1) mutually agree as to the value of any rewards offered to, and the reward criteria that must be met by, customers shopping within the network (1). This step is indicated at (18) in FIG. 5.

A printed coupon (13) as shown in FIG. 2 is freely distributed to prospective customers of the network at network vendor outlets or wherever prospective customers of the network (1) are likely to congregate. The coupon (13) includes an offer to the customer to become a member of the network. This step is indicated at (21) of FIG. 6. A customer may present the coupon (13) to a network vendor together with payment of an annual membership fee. By way of example, the annual fee is $88.00. After presenting the coupon and the membership fee, the customer receives a one-off initial discount of $500 off the regular price of goods and services provided by vendors in the network (1). The initial one-off offer serves as an initial enticement for customers to become members and commence shopping at vendors within the network (1). This step is indicated at (22) in FIG. 6. In other embodiments, the initial discount may be either larger or smaller than has been specified in the first embodiment.

The coupon (13) also allows a customer to provide his or her personal details such that when the customer presents the coupon (13) to a vendor to obtain membership, the vendor will have the customer's details at hand and can record these details accordingly for future reference.

The customer is also issued with a customer membership card (1) upon payment of the membership fee, which serves as a verification of the customer's membership. This step is also indicated at (22) in FIG. 6. The customer membership cards (11) are smart cards upon which the customer's details are stored including:
the identity of the customer;
the number of redeemable credits available to the customer at any given point in time;
the duration of validity of any redeemable credits available to the customer at any given time;

The customer membership card (11) is initialised with information regarding the customer's personal details, as well as the value of any initial credit the customer may have. In this case, the initial redeemable credit will be recorded as $500. The customer's information is also recorded into a customer account located on a central database (8). The central database (8) is initialised concurrently with the initialisation of the customer membership card (11). This step is indicated at (23) of FIG. 6. The information stored on the customer membership card (11) and in the central database (8) is updated whenever the customer has redeemed credit or when new credit has been acquired. This step is indicated at (27) of FIG. 6.

A customer who is a member of the network (1) is eligible to receive rewards from vendors in the network (1) whenever the customer meets a reward criteria of any given vendor. The provision of these rewards to the customer provides an incentive for the customer to continue shopping within the network (1). In this present embodiment there are two criteria which must be met in order for a reward to be issued. Firstly, the customer must make a purchase of goods or services from the vendor. This step is indicated at (25) in FIG. 6. Secondly, the customer must present a valid customer membership card (11) to the vendor as shown by step (26) in FIG. 6. The presentation of the customer membership card (11) provides verification that the customer is a valid member of the network (1) and thus entitled to receive benefits from shopping within the network (1).

In the present embodiment, the customer is rewarded by a rewarding vendor with a discrete amount of redeemable credit which is proportional to the purchase price of any goods or services purchased from the rewarding vendor. For instance, the plumber may decide to reward a customer with a redeemable credit equal to 10% of the value of plumbing services paid for by the customer—i.e if plumbing services amount to $1000, then the redeemable credit rewarded to the customer is worth $100. Thus, the customer is now able to redeem the $100 worth of credit as a discount off the price of goods or service at any vendor within the network.

In the present embodiment, each lot of credit provided to a customer must be redeemed in full and cannot be redeemed partially. Thus, if a customer seeks to purchase a platter of meat from the butcher (4) normally valued at $80 for a discount by redeeming the $100 credit issued by the plumber (6), the customer would need to redeem the entire $100 lot of credit. As no change is provided, the butcher may entice the customer to make a purchase of a further $80 platter of meat to maximise the full value of the $100 credit discount on offer. Thus, if the customer opts to purchase the further $80 platter of meat, the customer would pay a net value of $60 to the butcher to obtain the two $80 platters of meat at a discount of $100. The net $60 purchase price paid to the butcher may earn the customer a further reward of credit which in turn may be redeemed in full at a vendor store within the network so as to perpetuate the cycle of incentives.

It can be seen that, in this way, a customer may accumulate any number of discrete lots of redeemable credit at any given time. It is also possible for the customer to redeem multiple lots of redeemable credit to obtain a cumulative discount off the price of certain goods or services bearing in mind that each lot of credit redeemed is redeemed in full.

It should be noted that in this present embodiment, each vendor in the network may provide customers with redeemable credits which are calculated at different percentage rates to the purchase price spent on goods or services. For instance, the service station (2) may offer a reward of redeemable credit valued at 20% of the value of petrol purchased at the service station (2) whilst the dentist (3) may reward credit at the percentage rate of 15% of service fees paid, and so on. In this embodiment, the vendors will have mutually agreed upon the percentage discounts offered by each vendor in the network to avoid any confusion.

Each lot of credit which is issued to a customer must be redeemed at a vendor store within the network (1) before an expiry date assigned to the given lot of credit wherein the duration of the expiry date increases with the purchasing price paid by a customer in order to receive goods or services from a vendor. For instance, if the customer purchases goods or services to the value of between $0-$500, the credit is redeemable until a maximum period of 3 months from the date at which the credit was acquired; if the customer spends between $501-$1000, the credit is redeemable over a maximum period of 4 months from the date at which the credit was acquired; and if the customer spends more than $1000, the credit is redeemable over a maximum period of 6 months from the date at which the credit was acquired. In this way, customers are encouraged to spend larger amounts of money within the network (1) of vendors in order to receive redeemable credits of greater duration.

Although member vendors in the network (1) are able to set their own threshold purchase amounts for the expiry dates for credits, in this present embodiment, the vendors adhere to the same system to ensure consistency across the network (1).

In the present embodiment, the credit issued to a customer as a reward for making a purchase is redeemable at any vendor store including the store at which the credit was issued. In alternative embodiments of the present invention, a given lot of credit may be issued to a customer wherein the given lot of credit is not redeemable at the store at which the credit was acquired such that the customer is encouraged to shop at other vendors within the network (1).

An information directory is provided for public access over the Internet using a World Wide Web browser. The information directory presents the following information which is openly accessible to anyone with Internet access:
a listing of all vendors which are members of the network (1);
a listing of goods or services available from each member vendor in the network (1);
the number of credits which must be redeemed for certain goods or services offered by vendors in the network (1);

The information directory also presents information which may be only accessible to valid members of the network (1) using a password access scheme commonly known to persons skilled in the art. Such information includes:
the number and expiry date of credits available for redemption by a customer at any given time;
the expiry date assigned to credits for purchases of goods or services of any given amount.

Information which is published in the information directory is stored and retrieved from a central database (8) by a computer server (9). The server communicates with computer terminals (10) located at each vendor premises via the Internet and is physically located at a designated vendor store determined by the consensus of the member vendors which in this embodiment is the Internet service provider (7).

Each vendor in the network (1) is provided with a computer terminal (10) at its premises which is linked to the central database (8) via a dial-up communication link. Vendors are able to access and update information stored in the central database (8) using its computer terminal (10). In this embodiment, customer information is updated by the vendors using the terminals (10) whenever a customer is rewarded with new credit, or, redeems existing credit. The information contained in the customer's membership card (11) is also updated simultaneously.

Hence, by way of example, a member customer who is in need of a particular product will firstly consult the information directory to determine whether any of the vendors within the network (1) are able to provide the product in question. This step is indicated at (24) of FIG. 6. The incentive to consult the information directory exists in that the customer may have acquired for instance $100 worth of redeemable credit from past purchases within the network (1) and now wishes to redeem the given lot of credit in full for a discount.

Once the customer has found a listing in the information directory for a vendor that is able to supply the product in question, the customer will visit the relevant vendor's premises, and present his membership card (11). The customer will also nominate which lot of credit he wishes to redeem and the nominated credit will be discounted from the overall purchase price accordingly. Thus, if the normal cost of a bunch of flowers from the florist is $200, the customer would redeem the full $100 lot of credit rewarded by the plumber as a discount so as to pay a net purchase price of $100.

The vendor will also verify whether the customer has a valid customer membership card, and, whether the customer's credits have expired before a discount of the purchase price is provided to the customer. These steps are indicated at (26) and (28) respectively in FIG. 6. If these requirements are not satisfied, then the network vendor will refuse to provide a discount for the credit in question as indicated by (29) in FIG. 6.

After the transaction has completed, the changes to the customer's personal information are updated by the vendor both on the membership card (11), and, via the dial-up network (1) to the central database (8). In this example, the $100 credit used to obtain the discount will be deducted in full from the customer's records and the value of any new credit reward provided to the customer as a reward for making the purchase will be added to the customer's records both stored in the central database (8) and on the customer's membership card (11). These steps are indicated at (27) and (30) in FIG. 6.

Thus, it will be evident to a person skilled in the art that an incentive is provided to customers to continue shopping amongst vendors in the network (1) on an on-going basis.

The reference to any prior art in this specification is not, and should not be taken as, an acknowledgment or any form of suggestion that that prior art forms part of the common general knowledge in Australia.

Those skilled in the art will appreciate that the invention described herein is susceptible to variations and modifications other than those specifically described without departing from the scope of the invention. All such variations and modification which become apparent to persons skilled in the art, should be considered to fall within the spirit and scope of the invention as broadly hereinbefore described. It is to be understood that the invention includes all such variations and modifications. The invention also includes all of the steps and features, referred or indicated in the specification, individually or collectively, and any and all combinations of any two or more of said steps or features.

1. A method of providing incentives for customers to purchase goods or services from amongst a network of vendors including the step of providing a customer with a reward whenever the customer meets a reward criteria of a rewarding vendor, wherein the said reward is redeem able by a redeeming vendor in the network when the customer meets a redemption criteria of the said redeeming vendor, whereby, the redemption of the reward results in the redeeming vendor providing the customer with a further reward.

2. A method as claimed in claim 1 wherein the reward criteria includes the customer having to purchase goods or services from the rewarding vendor in the network.

3. A method as claimed in claim 2 wherein the reward criteria includes the customer having to present a membership card to the rewarding vendor.

4. A method as claimed in claim 3 wherein the reward includes a redeemable credit, said credit being redeemable for a discount on the cost of goods or services provided by the redeeming vendor.

5. A method as claimed in claim 4 wherein the credit is redeemable only at specified redeeming vendors in the network.

6. A method as claimed in claim 5 wherein the credit is redeemable within a specified time period.

7. A method as claimed in claim 6 wherein the specified time period is dependant upon the value of a purchase by a customer in order to obtain the credit.

8. A method as claimed in claim 7 wherein a customer is provided with an offer of a discount on goods or services from vendors in the network in exchange for the purchase of a membership card.

9. A method as claimed in the claim 8 wherein the offer is provided in the form of a coupon.

10. A method as claimed in claim 9 wherein the coupon is offered to the customer via an electronic medium.

11. A method as claimed in claim 10 wherein the electronic medium is the Internet.

12. A method as claimed in claim 11 wherein the membership card is a smart card.

13. A method as claimed in claim 12 wherein information is recorded on the smart card including the identity of the customer and the number of redeemable credit available to the customer at any given time.

14. A method as claimed in claim 13 wherein the information on the smart card is updated whenever the customer makes a purchase or redeems credit.

15. A method as claimed in claim 14 wherein the redemption criteria includes the customer having to redeem credit.

16. A method as claimed in claim 15 wherein the redemption criteria includes the customer having to redeem credit in full.

17. A method as claimed in claim 16 wherein the redemption criteria includes the customer having to purchase a good or service from the redeeming vendor.

18. A method as claimed in claim 17 including the step of providing an information directory, said information directory including details of the reward criteria, redemption criteria and the nature and availability of goods or services provided by each vendor in the network.

19. A method as claimed in claim 18 wherein the information directory is accessible electronically via the Internet using a World Wide Web browser.

20. A method as claimed in claim 18 wherein the information directory is updated periodically.

21. A method as claimed in claim 20 wherein the vendors in the network mutually agree as to the value of any rewards offered to, and/or reward criteria that must be met by the customer.

22. A method as claimed in claim 21 wherein each vendor in the network is both a redeeming vendor and a rewarding vendor.

23. A method as claimed in claim 22 wherein the network of vendors is established by selecting prospective vendors which meet a selection criteria.

24. A method as claimed in claim 23 wherein the selection criteria includes the location, and nature of goods or services sold by the prospective vendor.

25. A method as claimed in claim 24 wherein vendors in the network are issued with a vendor membership card.
